(19) United States
(12) Patent Application Publication
(10) Pub. No.: US 2025/0077892 A1
(43) Pub. Date: Mar. 6, 2025

(54) NEURAL NETWORK OPTIMIZATION WITH PREVIEW MECHANISM

(71) Applicant: MEDIATEK INC., Hsin-Chu (TW)

(72) Inventors: Chun-Wei Yang, Hsinchu City (TW); Cheng-Sheng Chan, Hsinchu City (TW); Min-Fong Horng, Hsinchu City (TW); Jui-Yang Hsu, Hsinchu City (TW); Sheng-Je Hung, Hsinchu City (TW)

(73) Assignee: MEDIATEK INC., Hsin-Chu (TW)

(21) Appl. No.: 18/239,759

(22) Filed: Aug. 30, 2023

(51) Int. Cl. G06N 3/0985

(52) U.S. Cl. CPC G06N 3/0985

(57) ABSTRACT

A neural network optimization method with a preview mechanism includes: in a preview stage, building an optimization space and obtaining multiple previewed results from the optimization space; generating an updating signal according to a reference value corresponding to the multiple previewed results, and processing the optimization space received in the preview stage according to the reference value; and in a view stage, receiving the optimization space and the updating signal, and processing the optimization space received in the view stage according to the updating signal to generate an optimization result.

### BACKGROUND

The present invention is related to neural network optimization, and more particularly, to a neural network optimization method with a preview mechanism and a non-transitory machine-readable medium for storing a program code that performs the neural network optimization method when executed.

With the development of artificial intelligence (AI), optimizing neural networks has gradually become an important issue. Take neural architecture search (NAS) as an example. Under a condition that a neural architecture is designed only through a training-required NAS algorithm, although it is possible to find a neural architecture with top quality, it may be quite time-consuming and require a large amount of computing resources. Under a condition that a neural architecture is designed only through a training-free NAS algorithm, although the NAS can be more efficient, the searched result may not be satisfying. As a result, it is urgently needed to provide a neural network optimization method with a preview mechanism, which can improve the efficiency of optimizing neural networks while saving time and computing resources.

### SUMMARY

It is therefore one of the objectives of the present invention to provide a neural network optimization method with a preview mechanism and a non-transitory machine-readable medium for storing a program code that provides the neural network optimization method when executed, to address the above-mentioned issues.

According to an embodiment of the present invention, a neural network optimization method with a preview mechanism is provided. The neural network optimization method comprises: in a preview stage, building an optimization space and obtaining multiple previewed results from the optimization space; generating an updating signal according to a reference value corresponding to the multiple previewed results, and processing the optimization space received in the preview stage according to the reference value; and in a view stage, receiving the optimization space and the updating signal, and processing the optimization space received in the view stage according to the updating signal to generate an optimization result.

According to an embodiment of the present invention, a non-transitory machine-readable medium for storing a program code, wherein when loaded and executed by a processor, the program code instructs the processor to perform a neural network optimization method with a preview mechanism, and the neural network optimization method comprises: in a preview stage, building an optimization space and obtaining multiple previewed results from the optimization space; generating an updating signal according to a reference value corresponding to the multiple previewed results, and processing the optimization space received in the preview stage according to the reference value; and in a view stage, receiving the optimization space and the updating signal, and processing the optimization space received in the view stage according to the updating signal to generate an optimization result.

One of the benefits of the present invention is that, by the neural network optimization method of the present invention, a preview mechanism is introduced into a neural network optimization algorithm to obtain possible optimization results of an optimization pipeline before the optimization pipeline is completed. In addition, the possible optimization results will be regarded as an indicator for optimization space adaption. In this way, the efficiency of optimizing neural networks can be improved while saving time and computing resources by stop optimizing the neural network with inferior optimization space, and an optimal optimization result can be achieved through iteratively adjusting the optimization space.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to an embodiment of the present invention.

FIG. 2 is a block diagram of a preview-view pipeline for neural network optimization according to an embodiment of the present invention.

FIG. 3 is a diagram illustrating implemental details of the preview stage shown in FIG. 2 according to an embodiment of the present invention.

FIG. 4 is a diagram illustrating implemental details of the adaptor stage shown in FIG. 2 according to an embodiment of the present invention.

FIG. 5 is a diagram illustrating implemental details of the view stage shown in FIG. 2 according to an embodiment of the present invention.

FIG. 6 is a flow chart of a neural network optimization method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

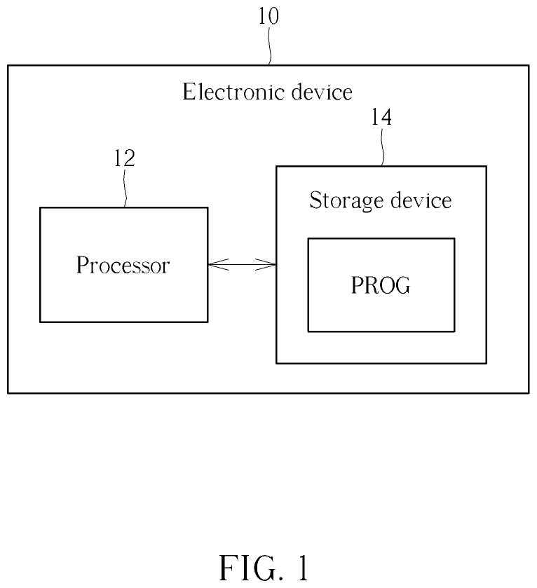

FIG. 1 is a diagram illustrating an electronic device 10 according to an embodiment of the present invention. By way of example, but not limitation, the electronic device 10 may be a portable device such as a smartphone or a tablet. The electronic device 10 may include a processor 12 and a storage device 14. The processor 12 may be a single-core processor or a multi-core processor. The storage device 14 is a non-transitory machine-readable medium, and is arranged to store computer program code PROG. The processor 12 is equipped with software execution capability. The computer program code PROG may include multiple neural network optimization algorithms (e.g. multiple neural architecture search (NAS) algorithms). When loaded and executed by the processor 12, the computer program code PROG instructs the processor 12 to perform a neural network optimization method with a preview mechanism as proposed by the present invention. The electronic device 10 may be regarded as a computer system using a computer program product that includes a computer-readable medium containing the computer program code PROG. That is, the neural network optimization method of the present invention may be embodied on the electronic device 10. In addition, the neural network optimization method of the present invention may be applied to the NAS, but the present invention is not limited thereto. Any types of neural network optimization can be implemented by the neural network optimization method of the present invention, and will fall within the scope of the present invention.

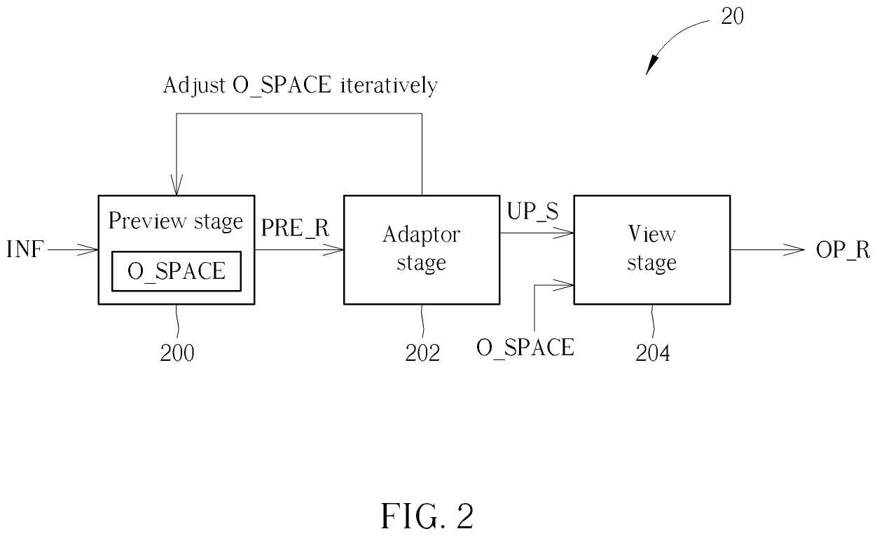

FIG. 2 is a block diagram of a preview-view pipeline 20 for neural network optimization according to an embodiment of the present invention. As shown in FIG. 2, the preview-view pipeline 20 may include a preview stage 200, an adaptor stage 202, and a view stage 204. In the preview stage 200, information INF may be received from a user, and an optimization space O_SPACE may be built according to the information INF, wherein the information INF may include a reference model, kernel size, channel number, and/or building blocks. Taking neural architecture search (NAS) as an example, the optimization space O_SPACE may be a search space. Before the preview-view pipeline 20 is completed, multiple previewed results PRE_R may be obtained from the optimization space O_SPACE received in the preview stage 200.

The multiple previewed results PRE_R may be possible optimization results of the preview-view pipeline 20, and may be provided from the preview stage 200 to the adaptor stage 202. In the adaptor stage 202, the optimization space O_SPACE received in the preview stage 200 may be adjusted iteratively according to a reference value REV corresponding to the multiple previewed results PRE_R, to reach an optimal optimization result. In addition, in the adaptor stage 202, an updating signal UP_S may be generated according to the reference value REV. In the view stage 204, the optimization space O_SPACE and the updating signal UP_S may be received, and the optimization space O_SPACE received in the view stage 204 may be processed according to the updating signal UP_S to generate an optimization result OP R. For example, the updating signal UP_S may indicate to update the optimization space O_SPACE received in the view stage 204 or stop viewing.

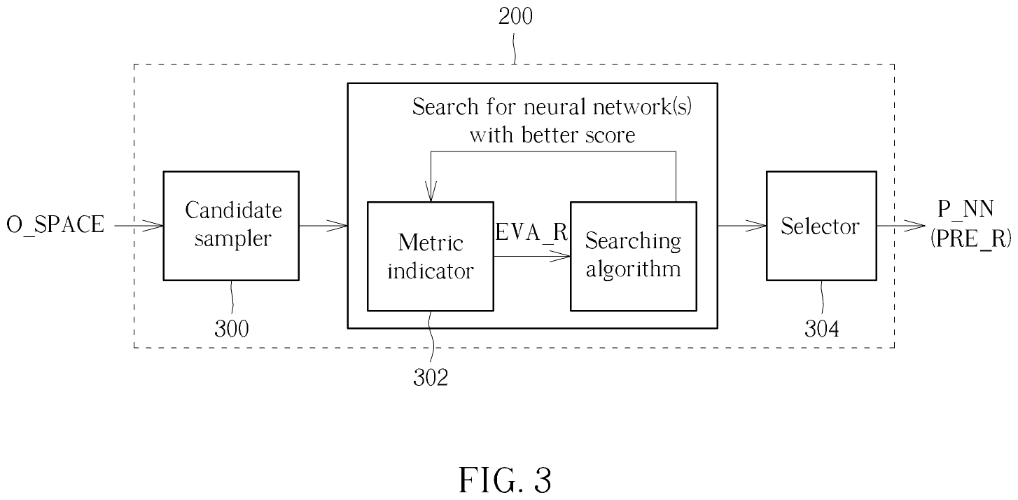

FIG. 3 is a diagram illustrating implemental details of the preview stage 200 shown in FIG. 2 according to an embodiment of the present invention. As shown in FIG. 3, the preview stage 200 may include a candidate sampler 300, a metric indicator 302, and a selector 304. The candidate sampler 300 may be arranged to sample the optimization space O_SPACE to obtain multiple candidate networks CAN_N. The metric indicator 302 may be arranged to evaluate/score the candidate networks CAN_N to obtain multiple evaluated results EVA_R, without training the candidate networks CAN_N. For example, a train-free quality metric may be utilized as a quality estimator, and the quality estimator may be regarded as the metric indicator 302 to estimate quality of the candidate networks CAN_N through quantifying the expressivity and/or trainability of the candidate networks CAN_N, for obtaining the evaluated results EVA_R. For another example, a model that estimates performance of a network may be utilized as a performance estimator, and the performance estimator may be regarded as the metric indicator 302 to estimate platform performance of the candidate networks CAN_N, for obtaining the evaluated results EVA_R. However, the present invention is not limited thereto. Any efficient metric estimator can be adopted as the metric indicator 302 in the preview stage 200.

Afterwards, multiple previewed neural networks P_NN may be obtained from the candidate networks CAN_N as the previewed results PRE_R according to the evaluated results EVA_R. For example, neural network(s) with better scores may be searched from the candidate networks CAN_N iteratively through a neural network optimization algorithm (e.g. a searching algorithm). In addition, the selector 304 may be arranged to select top-performing neural network(s) (i.e. the previewed neural networks P_NN) from the neural network(s) searched by the searching algorithm, to act as the previewed results PRE_R.

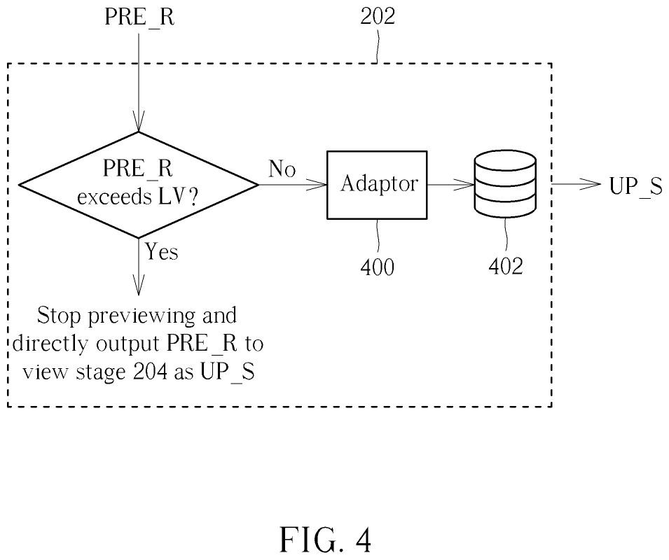

FIG. 4 is a diagram illustrating implemental details of the adaptor stage 202 shown in FIG. 2 according to an embodiment of the present invention. In the adaptor stage 202, it is determined that whether the reference value REF corresponding to the previewed results PRE_R exceeds a limitation value LV. For example, the limitation value LV may be a time TIM P predetermined by the user, and the reference value REF may be a time TIM for previewing the optimization space O_SPACE in the preview stage 200. That is, it is determined that whether the time TIM exceeds the time TIM P. For another example, the limitation value LV may be a criterion CRI predetermined by the user, and the reference value REF may be a metric MET for previewing the optimization space O_SPACE in the preview stage 200, wherein the metric MET may be indicative of quality of the previewed results PRE_R. That is, it is determined that whether the metric MET exceeds the criterion CRI.

In response to the reference value REF exceeding the limitation value LV, the optimization space O_SPACE received in the preview stage 200 will be stopped from previewing, and the previewed results PRE_R will be directly outputted to the view stage 204 as the updating signal UP_S. The adaptor stage 202 may include an adaptor 400. In response to the reference value REF not exceeding the limitation value LV, the adaptor 400 may be arranged to adjust the optimization space O_SPACE received in the preview stage 200 according to the reference value REF, to generate multiple adjusted optimization spaces AO_SPACE. For example, under a condition that the quality of the previewed results PRE_R is smaller than a result of subtracting a tolerance value TOLV from a predefined value PREV provided by the user (i.e. quality<PREV−TOLV), the adjusted optimization spaces AO_SPACE may be generated by enlarging the optimization space O_SPACE (e.g. enlarging the kernel size, the channel numbers and/or the block numbers of the optimization space O_SPACE). Under a condition that the quality of the previewed results PRE_R is larger than the result of subtracting the tolerance value TOLV from the predefined value PREV (i.e. quality>PREV−TOLV), the adjusted optimization spaces AO_SPACE may be generated by lowering the optimization space O_SPACE (e.g. lowering the kernel size, the channel numbers and/or the block numbers of the optimization space O_SPACE). In addition, the adaptor stage 202 may further include a space collector 402, wherein the space collector 402 may be arranged to collect the adjusted optimization spaces AO_SPACE for supporting asynchronous space updating.

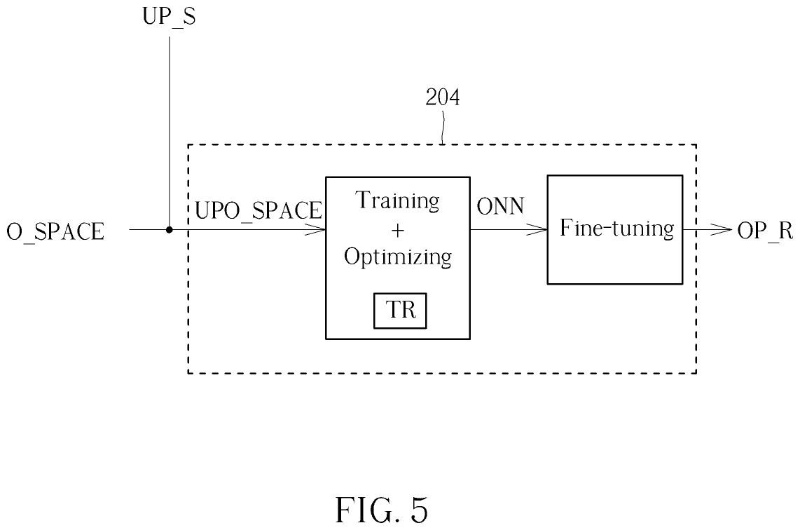

FIG. 5 is a diagram illustrating implemental details of the view stage 204 shown in FIG. 2 according to an embodiment of the present invention. As shown in FIG. 5, the view stage 204 may receive the optimization space O_SPACE and the updating signal UP_S, wherein the updating signal UP_S may indicate to update the optimization space O_SPACE received in the view stage 204 or stop viewing. Under a condition that the updating signal UP_S indicates to update the optimization space O_SPACE received in the view stage 204, the optimization space O_SPACE received in the view stage 204 may be updated according to the updating signal UP_S, to generate an updated optimization space UPO_SPACE. Afterwards, neural networks in the updated optimization space UPO_SPACE may be trained to obtain a training result TR, and the neural networks in the updated optimization space UPO_SPACE may be optimized according to the training result TR (e.g. for NAS, the optimization space UPO_SPACE may be searched with an objective provided by the user according to the training result TR), to generate optimized neural networks ONN. Finally, the optimized neural networks ONN may be fine-tuned to generate the optimization result OP R.

It should be noted that, regarding the neural network optimization method as proposed by the present invention, one of a time saving mode, a computation resource saving mode, and a thoroughly mode can be set to determine a configuration between the preview stage 200, the adaptor stage 202, and the view stage 204. In the time saving mode, the optimization space O_SPACE received in the view stage 204 will always be updated according to the updating signal UP_S to stop viewing on inferior optimization space, which will make the preview stage 200 and the view stage 204 executed on the same optimization space at the same time. In the computation resource saving mode, only when the reference value REF exceeds the limitation value LV, the updating signal UP_S indicates to update the optimization space O_SPACE received in the view stage 204. That is, viewing will be started only after previewing is completed to avoid viewing on inferior optimization space. In the thoroughly mode, all adjusted optimization spaces AO_SPACE collected in space collector 402 will be thoroughly viewed in the view stage 204.

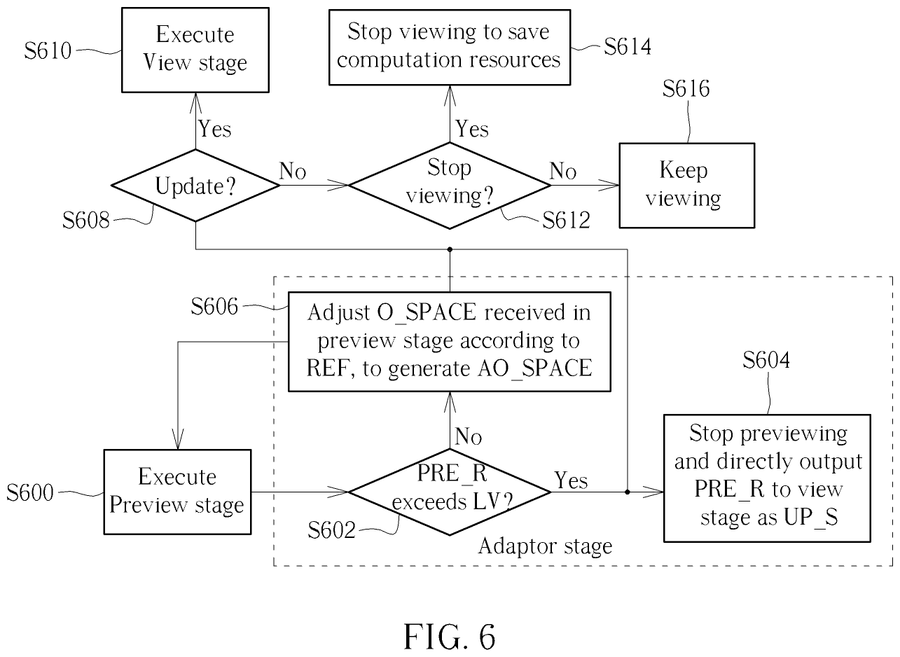

FIG. 6 is a flow chart of a neural network optimization method according to an embodiment of the present invention. Provided that the result is substantially the same, the steps are not required to be executed in the exact order shown in FIG. 6. For example, the neural network optimization method shown in FIG. 6 may be employed by the electronic device 10 shown in FIG. 1.

In Step S600, the preview stage 200 is executed to obtain the previewed results PRE_R from the optimization space O_SPACE received in the preview stage 200 before the preview-view pipeline 20 is completed.

In Step S602, the adaptor stage 202 is executed to determine whether the reference value REF corresponding to the previewed results PRE_R exceeds the limitation value LV. If yes, Steps S604 and S608 are entered; if no, Step S606 is entered.

In Step S604, in response to the reference value REF exceeding the limitation value LV, the optimization space O_SPACE received in the preview stage 200 will be stopped from previewing, and the previewed results PRE_R will be directly outputted to the view stage 204 as the updating signal UP_S.

In Step S606, in response to the reference value REF not exceeding the limitation value LV, the adaptor 400 may be arranged to adjust the optimization space O_SPACE received in the preview stage 200 according to the reference value REF, to generate the adjusted optimization spaces AO_SPACE, wherein the adjusted optimization spaces AO_SPACE is collected by the space collector 402 for supporting asynchronous space updating.

In Step S608, it is determined that whether to update the optimization O_SPACE received in the view stage 204 according to the updating signal UP_S and a setting mode (e.g. one of the time saving mode, the computation resource saving mode, and the thoroughly mode). If yes, Step S610 is entered; if no, Step S612 is entered.

In Step S610, the view stage 200 is executed to update the optimization space O_SPACE received in the view stage 204 according to the updating signal UP_S, to generate the updated optimization space UPO_SPACE, wherein neural networks in the updated optimization space UPO_SPACE may be trained to obtain the training result TR, the neural networks in the updated optimization space UPO_SPACE may be optimized according to the training result TR to generate the optimized neural networks ONN, and the optimized neural networks ONN may be fine-tuned to generate the optimization result OP R.

In Step S612, it is determined whether to stop viewing according to the setting mode. If yes, Step S614 is entered; if no, Step S616 is entered.

In Step S614, viewing is stopped to save computation resources.

In Step S616, viewing is kept.

Since a person skilled in the pertinent art can readily understand details of the steps after reading above paragraphs, further description is omitted here for brevity.

In summary, by the neural network optimization method of the present invention, a preview mechanism is introduced into a neural network optimization algorithm to obtain possible optimization results of an optimization pipeline before the optimization pipeline is completed. In addition, the possible optimization results will be regarded as an indicator for optimization space adaption. In this way, the efficiency of optimizing neural networks can be improved while saving time and computing resources by stop optimizing the neural network with inferior optimization space, and an optimal optimization result can be achieved through iteratively adjusting the optimization space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A neural network optimization method with a preview mechanism, comprising:
in a preview stage, building an optimization space and obtaining multiple previewed results from the optimization space;
generating an updating signal according to a reference value corresponding to the multiple previewed results, and processing the optimization space received in the preview stage according to the reference value; and
in a view stage, receiving the optimization space and the updating signal, and processing the optimization space received in the view stage according to the updating signal to generate an optimization result.

2. The neural network optimization method of claim 1, wherein the step of obtaining the multiple previewed results from the optimization space comprises:
sampling the optimization space to obtain multiple candidate networks;
evaluating the multiple candidate networks to obtain multiple evaluated results; and
obtaining multiple previewed neural networks from the multiple candidate networks as the multiple previewed results according to the multiple evaluated results.

3. The neural network optimization method of claim 2, wherein the step of evaluating the multiple candidate networks to obtain the multiple evaluated results comprises:
utilizing a quality estimator to estimate quality of the multiple candidate networks for obtaining the multiple evaluated results.

4. The neural network optimization method of claim 2, wherein the step of evaluating the multiple candidate networks to obtain the multiple evaluated results comprises:
utilizing a performance estimator to estimate platform performance of the multiple candidate networks for obtaining the multiple evaluated results.

5. The neural network optimization method of claim 1, wherein the step of generating the updating signal according to the reference value corresponding to the multiple previewed results, and processing the optimization space received in the preview stage according to the reference value comprises:
determining whether the reference value exceeds a limitation value;
in response to the reference value exceeding the limitation value, stopping previewing the optimization space received in the preview stage, and directly outputting the multiple previewed results to the view stage as the updating signal;
in response to the reference value not exceeding the limitation value, adjusting the optimization space received in the preview stage according to the reference value, to generate multiple adjusted optimization spaces; and
collecting the multiple adjusted optimization spaces.

6. The neural network optimization method of claim 5, wherein the reference value is a time for previewing the optimization space received in the preview stage, the limitation value is a predetermined time, and the step of determining whether the reference value exceeds the limitation value comprises:
determining whether the time exceeds the predetermined time.

7. The neural network optimization method of claim 5, wherein the reference value is a metric for previewing the optimization space received in the preview stage, the limitation value is a predetermined criterion, and the step of determining whether the reference value exceeds the limitation value comprises:
determining whether the metric exceeds the predetermined criterion.

8. The neural network optimization method of claim 1, wherein the step of processing the optimization space received in the view stage according to the updating signal to generate the optimization result comprises:
updating the optimization space received in the view stage according to the updating signal, to generate an updated optimization space;
training neural networks in the updated optimization space to obtain a training result;
optimizing the neural networks in the updated optimization space according to the training result, to generate optimized neural networks; and
fine-tuning the optimized neural networks to generate the optimization result.

9. The neural network optimization method of claim 1, wherein the step of processing the optimization space received in the view stage according to the updating signal comprises:
stopping viewing the optimization space received in the view stage according to the updating signal.

10. The neural network optimization method of claim 1, wherein the neural network optimization method is applied to a neural architecture search (NAS).

11. A non-transitory machine-readable medium for storing a program code, wherein when loaded and executed by a processor, the program code instructs the processor to perform a neural network optimization method with a preview mechanism, and the neural network optimization method comprises:
in a preview stage, building an optimization space and obtaining multiple previewed results from the optimization space;
generating an updating signal according to a reference value corresponding to the multiple previewed results, and processing the optimization space received in the preview stage according to the reference value; and
in a view stage, receiving the optimization space and the updating signal, and processing the optimization space received in the view stage according to the updating signal to generate an optimization result.

12. The non-transitory machine-readable medium of claim 11, wherein the step of obtaining the multiple previewed results from the optimization space comprises:
sampling the optimization space to obtain multiple candidate networks;
evaluating the multiple candidate networks to obtain multiple evaluated results; and
obtaining multiple previewed neural networks from the multiple candidate networks as the multiple previewed results according to the multiple evaluated results.

13. The non-transitory machine-readable medium of claim 12, wherein the step of evaluating the multiple candidate networks to obtain the multiple evaluated results comprises:
utilizing a quality estimator to estimate quality of the multiple candidate networks for obtaining the multiple evaluated results.

14. The non-transitory machine-readable medium of claim 12, wherein the step of evaluating the multiple candidate networks to obtain the multiple evaluated results comprises:
utilizing a performance estimator to estimate platform performance of the multiple candidate networks for obtaining the multiple evaluated results.

15. The non-transitory machine-readable medium of claim 11, wherein the step of generating the updating signal according to the reference value corresponding to the multiple previewed results, and processing the optimization space received in the preview stage according to the reference value comprises:
determining whether the reference value exceeds a limitation value;
in response to the reference value exceeding the limitation value, stopping previewing the optimization space received in the preview stage, and directly outputting the multiple previewed results to the view stage as the updating signal;
in response to the reference value not exceeding the limitation value, adjusting the optimization space received in the preview stage according to the reference value, to generate multiple adjusted optimization spaces; and
collecting the multiple adjusted optimization spaces.

16. The non-transitory machine-readable medium of claim 15, wherein the reference value is a time for previewing the optimization space received in the preview stage, the limitation value is a predetermined time, and the step of determining whether the reference value exceeds the limitation value comprises:
determining whether the time exceeds the predetermined time.

17. The non-transitory machine-readable medium of claim 15, wherein the reference value is a metric for previewing the optimization space received in the preview stage, the limitation value is a predetermined criterion, and the step of determining whether the reference value exceeds the limitation value comprises:
determining whether the metric exceeds the predetermined criterion.

18. The non-transitory machine-readable medium of claim 11, wherein the step of processing the optimization space received in the view stage according to the updating signal comprises:
updating the optimization space received in the view stage according to the updating signal, to generate an updated optimization space;
training neural networks in the updated optimization space to obtain a training result;
optimizing the neural networks in the updated optimization space according to the training result to generate optimized neural networks; and
fine-tuning the optimized neural networks to generate the optimization result.

19. The non-transitory machine-readable medium of claim 11, wherein the step of processing the optimization space received in the view stage according to the updating signal comprises:
stopping viewing the optimization space received in the view stage according to the updating signal.

20. The non-transitory machine-readable medium of claim 11, wherein the neural network optimization method is applied to a neural architecture search (NAS).
